(19) United States
(12) Patent Application Publication
(10) Pub. No.: US 2010/0014425 A1
(43) Pub. Date: Jan. 21, 2010

(54) METHOD FOR BALANCING OF MODEM LOAD

(75) Inventors: Shu-Min Cheng, Tu-Cheng (TW); Yew-Min Lo, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/261,037

(22) Filed: Oct. 30, 2008

(30) Foreign Application Priority Data
Jul. 18, 2008 (CN) 200810302789.0

(51) Int. Cl. H04L 12/56

(52) U.S. Cl. 370/235

(57) ABSTRACT

A method for achieving load balance of a modem (21) corresponding to a terminal (20) in a network (100) comprises selecting upstream channel descriptors (UCDs) in the network, checking the terminal for any proven-usable UCD records, determining a prior range of the UCDs according to the checking result, selecting the UCDs in the prior range and checking upstream channels corresponding thereto, and marking the unusable UCDs and storing the UCDs corresponding to usable upstream channel as new proven-usable records in the terminal.

### BACKGROUND OF THE INVENTION

1. Field of the Invention

The present invention generally relates to methods for balancing modem load, particularly to an active method for balancing modem load.

2. Description of Related Art

A network having a plurality of terminals allows multiple synchronous terminals to get upstream channel descriptors (UCDs) from a cable modem terminal system (CMTS) of the network. Since the terminal can select a usable upstream channel, the cable modem corresponding to the terminal can balance a working load through the upstream channel.

Referring to FIG. 3, a commonly-used method for balancing modem load of a network comprises using the CMTS to collect all UCDs therein, using the modem to select each UCD and check upstream channels corresponding thereto on a first-in first-out (FIFO) basis, and, if a selected UCD does not correspond to a usable upstream channel, marking the UCD as unusable, subsequently selecting another unmarked UCD and checking its corresponding channel. When a selected UCD corresponds to a usable upstream channel, the upstream channel provides load balance of the modem. Generally, this method is known to be a passive load balance method.

However, the passive load balance method presents drawbacks. In a network, there is usually a large number of UCDs in a CMTS thereof. Collecting all of these UCDs in FIFO order and checking their upstream channels one-by-one is time-consuming and requires significant system resources. Furthermore, in this method, each modem selects UCDs and checks upstream channels thereof according to a FIFO order. If multiple modems are connected to a CMTS of a network and operate simultaneously, a plurality of the modems may select a common UCD in the CMTS and attempt to check its corresponding upstream channel at the same time. Loading on the upstream channel is increased, affecting function of the CMTS.

Therefore, a method for balancing modem load overcoming the described limitations is called for.

### BRIEF DESCRIPTION OF THE DRAWINGS

Many aspects of the method for balancing modem load can be better understood with references to the following drawings. The components in the drawings are not necessarily drawn to scale, the emphasis instead being placed upon clearly illustrating the principles of the new method for balancing modem load. Moreover, in the drawings, like reference numerals designate corresponding parts throughout the several views.

FIG. 1 is a diagram of a network employing a method for balancing modem load according to an exemplary embodiment.

FIG. 2 is a flowchart of the method for balancing modem load of FIG. 1.

FIG. 3 is a flowchart of a commonly used method for balancing modem load.

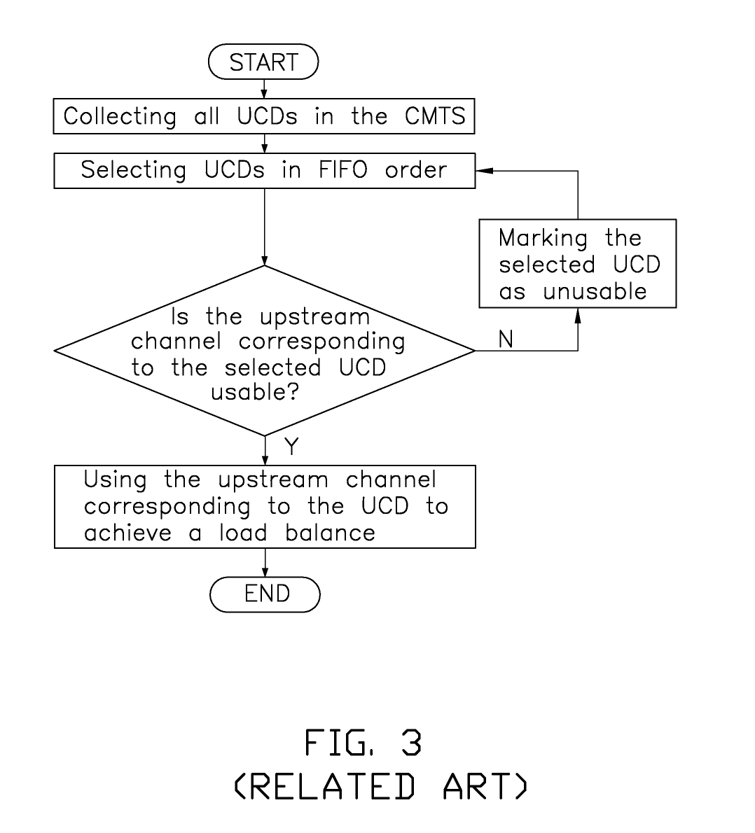

### DETAILED DESCRIPTION OF THE INVENTION

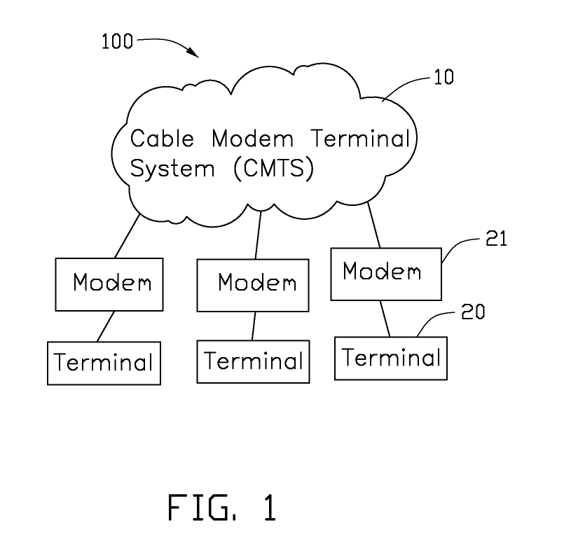

Referring to FIG. 1, an exemplary embodiment of a network 100 employing a method for balancing modem load includes at least one cable modem terminal system (CMTS) 10 and a plurality of terminals 20. The terminals 20 can be televisions, computers, or other data processors. Each terminal 20 is connected to the CMTS 10 through a corresponding modem 21. In use, the terminal 20 employs a corresponding modem 21 to collect upstream channel descriptors (UCDs) in the CMTS 10, and selects a UCD corresponding to a usable upstream channel. When a UCD corresponding to a usable upstream channel is found, the modem 21 corresponding to the terminal 20 uses the usable upstream channel to achieve a load balance. The terminal 20 can store the usable UCD as a proven-usable UCD record therein.

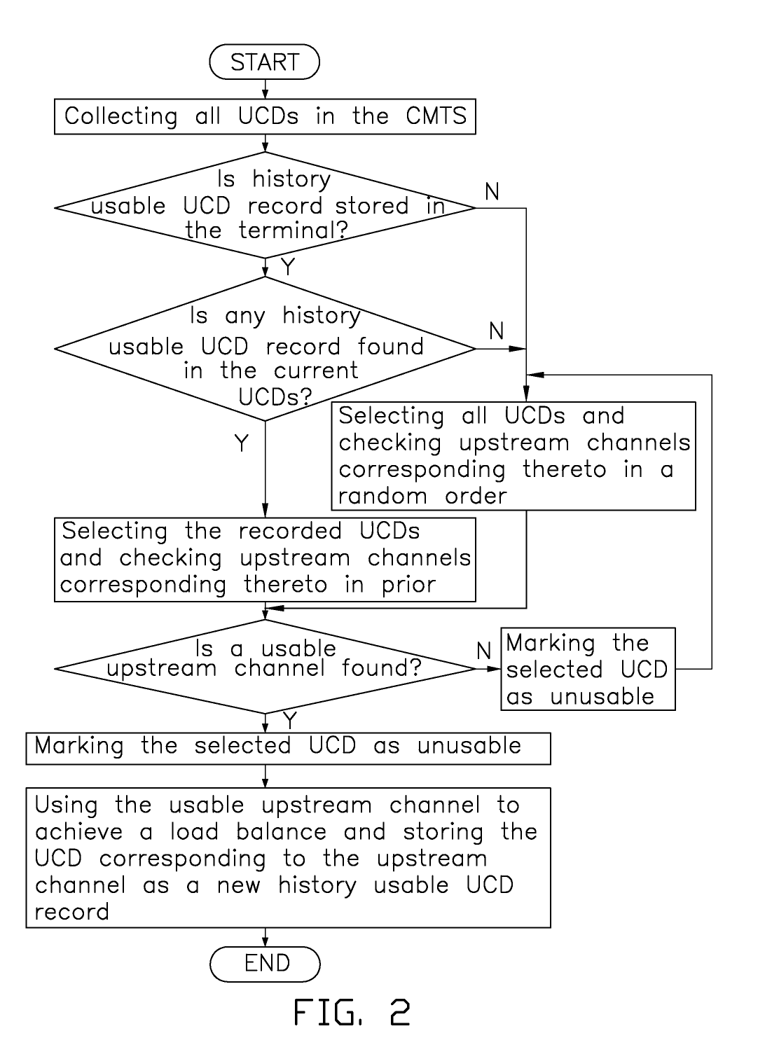

Also referring to FIG. 2, a method for balancing modem load 20 in the network 100, according to an exemplary embodiment, is provided. The method comprises providing the aforementioned network 100. A terminal 20 of the network 100 collects all UCDs in the CMTS 10 through its corresponding modem 21. After all UCDs in the CMTS 10 have been collected by the terminal 20, it is determined whether there is a proven-usable UCD record stored in the terminal 20.

If no history of a proven-usable UCD is found in the terminal 20, the modem 21 corresponding to the terminal 20 selects all collected UCDs and checks corresponding upstream channels in random order.

During selection and checking, if a selected UCD does not correspond to a usable upstream channel, the UCD is marked as unusable, and the subsequent unmarked UCD is selected and its corresponding channel checked. When a selected UCD corresponds to a usable upstream channel, selection and checking is stopped, and the modem 21 uses the upstream channel to achieve a load balance. The terminal 20 stores the usable UCD as a new usable UCD record therein. If no selected UCDs correspond to a usable upstream channel, the terminal 20 issues notification that it has failed to communicate with the network 100, indicating a requirement to check the network 100 or reconnect the terminal 20 to the network 100.

If at least one proven-usable UCD record is found in the terminal 20, the terminal 20 compares the current collected UCDs therewith to determine a prior selection and checking range in the collected UCDs according to the comparison results, and first select UCDs in the range and check upstream channels corresponding thereto.

In the comparison, if at least one of the current collected UCDs matches the usable UCD history, the terminal 20 marks these proven-usable UCD records as a prior selection and checking range. Thus, the terminal 20 selects the UCDs in the prior range, and checks the upstream channels accordingly. A selection and checking order of the UCDs in the prior range is random.

During selection and checking in the prior range, if a selected UCD does not correspond to a usable upstream channel, the UCD is marked as unusable and deleted from the usable UCD history, the subsequent UCD in the prior range is selected and its corresponding channel checked. When a selected UCD corresponds to a usable upstream channel, selection and checking is stopped, and the modem 21 uses the upstream channel to achieve a load balance, and the proven-usable UCD record of the selected UCD is retained in the terminal 20.

If none of the UCDs in the prior range corresponds to a usable upstream channel, the terminal 20 completely deletes the usable UCD history, and selects all current UCDs outside the prior range and checks their corresponding upstream channels in a random order. Similar to the lack of usable UCD records in the collection of UCDs stored in history, in this selection and checking process, if a selected UCD does not correspond to a usable upstream channel, the UCD is marked as unusable and the subsequent unmarked UCD is selected and its corresponding channel checked. When a selected UCD corresponds to a usable upstream channel, selection and checking is stopped, and the modem 21 uses the upstream channel to achieve a load balance. The terminal 20 stores the usable UCD as a new usable UCD record therein. If none of the UCDs outside of the prior range correspond to a usable upstream channel, the terminal 20 issues notification that it has failed to communicate with the network 100, indicating a requirement to check the network 100 or reconnect the terminal 20 to the network 100.

Furthermore, if none of the collected UCDs matches the history of usable UCDs, the terminal 20 directly selects all currently collected UCDs and checks their corresponding upstream channel in a random order. Similar to the lack of usable UCD records being found in the current collection of UCDs, in this selection and checking process, if a selected UCD does not correspond to a usable upstream channel, the UCD is marked as unusable and the subsequent unmarked UCD is selected and its corresponding channel checked. When a selected UCD corresponds to a usable upstream channel, selection and checking is stopped, and the modem 21 uses the upstream channel to achieve a load balance. The terminal 20 stores the usable UCD as a new usable UCD record therein. If none of the UCDs outside of the prior range corresponds to a usable upstream channel, the terminal 20 issues notification that it has failed to communicate with the network 100, indicating a necessity to check the network 100 or reconnect the terminal 20 to the network 100.

Understandably, once the modem 21 corresponding to the terminal 20 acquires a usable upstream channel to achieve a load balance, the terminal 20 stores at least one usable UCD record therein. When the modem 21 selects a usable upstream channel again, it can first check the upstream channel corresponding to the usable UCD history.

In the exemplary method for achieving a load balance of the modem 21, the terminal 20 actively selects and manages UCDs in the network 100, reducing workload of the CMTS 10. When the terminal 20 storing the usable UCD history therein is used again, its corresponding modem 21 can firstly select the recorded UCDs and check the upstream channel corresponding thereto. Thus, the modem 21 has a better possibility of finding a UCD corresponding to a usable upstream channel in a smaller selection and checking range. In this way, the selection and checking work can be reduced.

Additionally, when no UCD in the usable UCD history corresponds to a usable upstream channel, the terminal 20 selects other collected UCDs in a random order. When a plurality of terminals 20 is connected to the network 100 and all are operating properly, the modems 21 of these terminals are prevented from selecting a common UCD and checking its corresponding upstream channel at the same time. Thus, the network 100 is protected from sudden load increase and corresponding operational difficulties.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for achieving load balance of a modem corresponding to a terminal in a network, comprising:
selecting upstream channel descriptors (UCDs) in the network;
checking the terminal for history of a usable UCD therein;
determining a prior range of the UCDs according to the result;
selecting the UCDs in the prior range and checking upstream channels corresponding thereto; and
marking the UCDs corresponding to unusable upstream channel as unusable, and storing the UCDs corresponding to usable upstream channels as new proven-usable records in the terminal.

2. The method as claimed in claim 1, further comprising selecting all UCDs and checking upstream channels corresponding thereto when no usable UCD record is found in the terminal.

3. The method as claimed in claim 2, wherein selection of all UCDs and checking of upstream channels corresponding thereto is random.

4. The method as claimed in claim 1, further comprising comparing the current UCDs with the usable UCD history when at least one usable UCD record is found in the terminal, and determining the prior range according to the comparison results.

5. The method as claimed in claim 4, further comprising, if at least one of the current UCDs matches the usable UCD history, marking the usable UCD history matching the current UCDs as the prior range, and selecting the UCDs in the prior range and checking the upstream channels corresponding thereto.

6. The method as claimed in claim 5, further comprising, when a selected UCD in the prior range corresponds to a usable upstream channel, using the upstream channel to achieve a load balance of the modem, and retaining the usable UCD record of the selected UCD.

7. The method as claimed in claim 5, further comprising, if none of the UCDs in the prior range corresponds to a usable upstream channel, deleting all usable UCD history from the terminal, and selecting all current UCDs out of the prior range and checking their corresponding upstream channel.

8. The method as claimed in claim 7, wherein selection of all current UCDs and checking of upstream channels corresponding thereto is random.

9. The method as claimed in claim 4, further comprising selecting all current UCDs and checking their corresponding upstream channel when none of the current UCDs matches the usable UCD history.

10. The method as claimed in claim 9, wherein all current UCDs are selected and upstream channels corresponding thereto checked in random order.
